(19) United States
(12) Patent Application Publication
(10) Pub. No.: US 2025/0278108 A1
(43) Pub. Date: Sep. 4, 2025

(54) KNOB MECHANISM

(71) Applicant: TEREX SOUTH DAKOTA, INC., Watertown, SD (US)

(72) Inventors: Yogesh RJ, Bengaluru (IN); Sendil MUTHUSWAMY, Bengaluru (IN); Prathap MURALIDHARA, Bengaluru (IN); Ankith RAVISHANKAR, Bengaluru (IN); Charles SUNNY, Bengaluru (IN); Abin PETER, Bengaluru (IN)

(73) Assignee: TEREX SOUTH DAKOTA, INC., Watertown, SD (US)

(21) Appl. No.: 18/593,697

(22) Filed: Mar. 1, 2024

(51) Int. Cl. G05G 5/08; B66F 11/04; G05G 1/08

(52) U.S. Cl. CPC G05G 5/08; B66F 11/046; G05G 1/085

(57) ABSTRACT

A knob mechanism according to the disclosure may include a knob body and a lock mechanism associated with the knob body. The lock mechanism may include a locking member that is movable between an extended position and a retracted position, a pivot member that is pivotable with respect to the knob body to move the locking member, and a button that is operable to pivot the pivot member to move the locking member from the extended position toward the retracted position.

### TECHNICAL FIELD

The disclosure relates to a knob mechanism.

### BACKGROUND

A prior crank handle including a knob for a lift device is disclosed in International Publication No. WO 2013/140149 A1.

### SUMMARY

A knob mechanism according to the disclosure may include a knob body and a lock mechanism associated with the knob body. The lock mechanism may include a locking member that is movable between an extended position and a retracted position, a pivot member that is pivotable with respect to the knob body to move the locking member, and a button that is operable to pivot the pivot member to move the locking member from the extended position toward the retracted position.

While exemplary embodiments are illustrated and disclosed, such disclosure should not be construed to limit the claims. It is anticipated that various modifications and alternative designs may be made without departing from the scope of the disclosure.

### BRIEF DESCRIPTION OF THE DRAWINGS

FIG. 1 is a perspective view of an example lift including a support member arrangement shown in a lowered position, and a drive system for moving the support member arrangement, wherein the drive system includes a knob mechanism according to disclosure;

FIG. 2 is a perspective view of the lift of FIG. 1 with the support member arrangement shown in a raised position;

FIG. 3A is a front view of the support member arrangement including first, second and third upright support members, wherein the second upright support member is shown in section and the third upright support member is partially broken away to show first and second drive members of the drive system positioned inside of the second and third upright support members, respectively;

FIG. 3B is a top view of the support member arrangement and drive system;

FIG. 4 is a schematic diagram of the support member arrangement;

FIG. 5 is an enlarged front view of a portion of the drive system including the knob mechanism; and

FIG. 6 is an enlarged perspective view of the knob mechanism;

FIG. 7 is a side cross-sectional view of the knob mechanism in an extended or locked position;

FIG. 8 is a side cross-sectional view of the knob mechanism in a retracted position;

FIG. 9 is a side view of the knob mechanism mounted on a rotatable member of the drive system;

FIG. 10 is an exploded perspective view of the knob mechanism;

FIG. 11 is a perspective view of another embodiment of a knob mechanism according to the disclosure;

FIG. 12 is an exploded view of the knob mechanism shown in FIG. 11;

FIG. 13 is a side cross-sectional view of the knob mechanism of FIG. 11 shown in an extended or locked position;

FIG. 14 is a side cross-sectional view of the knob mechanism of FIG. 11 in a retracted position;

FIG. 15 is a perspective view of yet another embodiment of a knob mechanism according to the disclosure;

FIG. 16 is a side cross-sectional view of the knob mechanism of FIG. 15 shown in an extended or locked position; and

FIG. 17 is a side cross-sectional view of the knob mechanism of FIG. 15 in a retracted position.

### DETAILED DESCRIPTION

As required, detailed embodiments are disclosed herein. However, it is to be understood that the disclosed embodiments are merely exemplary, and that various and alternative forms may be employed. The figures are not necessarily to scale; some features may be exaggerated or minimized to show details of particular components. Therefore, specific structural and functional details disclosed herein are not to be interpreted as limiting, but merely as a representative basis for teaching one skilled in the art.

As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising” specify the presence of stated features, integers, steps, operations, elements, and/or components, but do not preclude the presence or addition of one or more other features, integers, steps, operations, elements, components, and/or groups thereof.

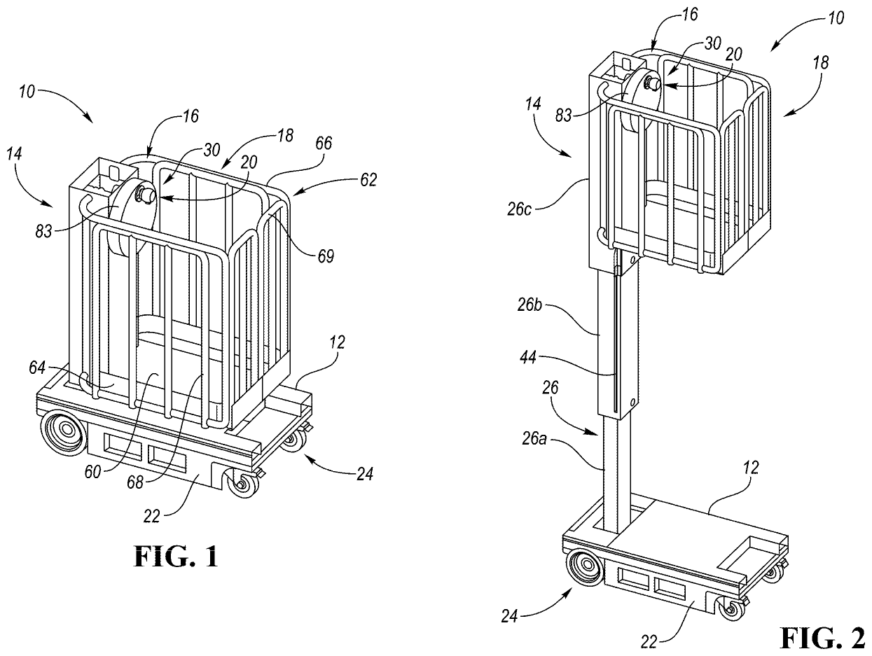

FIGS. 1 and 2 show an example lift device or lift 10, such as a boom lift or aerial work platform. The lift 10 includes a base 12, a support member arrangement 14 attached to the base 12, a drive system 16 that is operable to move the support member arrangement 14 between a lowered position, shown in FIG. 1, and a raised position, shown in FIG. 2, and a work platform assembly 18 connected to the support member arrangement 14 and configured to receive an operator. As explained below, the drive system 16 includes a novel knob mechanism 20 (e.g., handle mechanism) according to the disclosure, and the knob mechanism 20 may function as a locking mechanism for locking the support member arrangement 14 in a desired position. As another example, the knob mechanism 20 may be used in any other suitable application (e.g., device) in which it may be desirable to lock one component (e.g., rotatable component) with respect to another component.

The base 12 of the lift 10 shown in FIGS. 1 and 2 is configured to support the support member arrangement 14, along with the rest of the lift 10, and includes a main body 22, such as a rigid support structure, and one or more support members 24, such as wheels, casters, tracks, outriggers, etc., attached to the main body 22. In the illustrated embodiment, the lift 10 includes multiple support members 24 formed as wheels and associated tires, so that the base 12 is movable. Furthermore, two or more of the wheels are pivotable in order to steer the base 12.

The support member arrangement 14 may include one or more movable support members 26, such as pivotable and/or linearly movable booms, masts, tubes, columns, arms, etc., attached to the base 12. In the illustrated embodiment, the support member arrangement 14 includes first, second and third upright support members 26a, 26b and 26c, respectively, and the second and third upright support members 26b and 26c, respectively, are linearly movable with respect to the first upright support member 26a when the support member arrangement 14 moves between the lowered and raise positions. In another embodiment, the support member arrangement 14 may include two upright support members, wherein one of the upright support members may be movable with respect to the other upright support member.

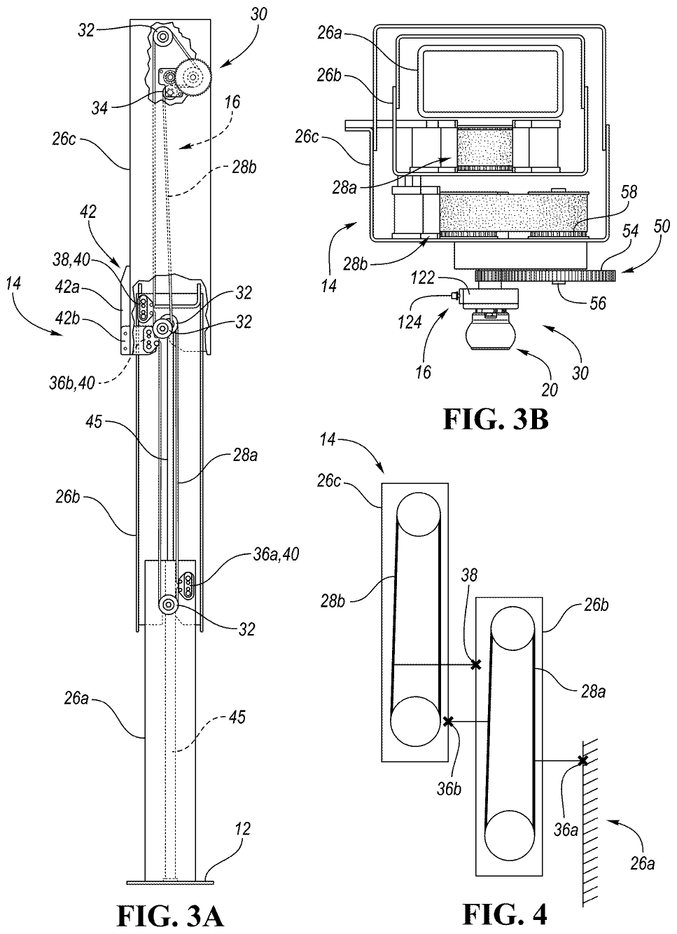

Referring to FIGS. 1-4, the drive system 16 may have any suitable configuration that is operable to move one or more of the support members 26 in order to move the support member arrangement 14 between the lowered and raised positions. For example, the drive system 16 may include one or more drive members 28, such as flexible drive members (e.g., strands, belts, chains and/or cables that may be arranged as one or more pulley mechanisms, for example), rigid drive members (e.g., rack and pinion systems, rotatable shafts and gears), etc., and one or more actuators, such as a manually operable (i.e., hand-operated) actuator 30 for moving the drive members 28. In the illustrated embodiment, the drive system 16 includes movable first and second flexible drive members 28a and 28b, respectively, which may be lower and upper drive members, respectively. Furthermore, each drive member 28a, 28b may have any suitable form or configuration, such as a strand, belt, chain, cable, or other flexible member. As a more detailed example, each drive member 28a, 28b may be a continuous drive member that is movable (e.g., circulatable or reciprocatable) with respect to one or more rotatable members 32, such as pulleys, rollers, wheels, sheaves, etc. In the illustrated embodiment, the first drive member 28a is movable about or at least partially around two rotatable members 32 attached at opposite ends of the second upright support member 26b (e.g., mounted on an interior surface of the second upright support member 26b), and the second drive member 28b is movable about or at least partially around two rotatable members 32 attached at opposite ends of the third upright support member 26c (e.g., mounted on an interior surface of the third upright support member 26c), so that a portion of each drive member 28a, 28b may reciprocate (e.g., move back and forth) between the respective two rotatable members 32. In the illustrated embodiment, the drive system 16 also includes an idler rotatable member 34, such as a pulley, roller, wheel, sheave, etc., for the second drive member 28b that is positioned between the rotatable members 32 associated with the second drive member 28b. In addition, in the embodiment shown in FIGS. 3A and 3B, the first drive member 28a is positioned or extends between the second upright support member 26b and the first upright support member 26a (e.g., between the interior surface of the second upright support member 26b and an exterior surface, such as a front face, of the first upright support member 26a), and the second drive member 28b is positioned or extends between the third upright support member 26c and the second upright support member 26b (e.g., between the interior surface of the third upright support member 26c and an exterior surface, such as a front face, of the second upright support member 26b).

In the illustrated embodiment, the first drive member 28a is movably received or positioned within the second upright support member 26b and fixedly connected to the first upright support member 26a at a fixed connection location 36a (e.g., within the second upright support member 26b) and to the third upright support member 26c at a fixed connection location 36b (e.g., within the third upright support member 26c or on an exterior of the third upright support member 26c), and the second drive member 28b is movably received or positioned within the third upright support member 26c and fixedly connected to the second upright support member 26b at a fixed connection location 38 (e.g., within the third upright support member 26c). With such a configuration, load from the third upright support member 26c may be transferred to one side of the first drive member 28a, and force or tension in the second drive member 28b resulting from the actuator 30 may be transferred to the second support member 26b. In addition, the first and second drive members 28a and 28b, respectively, are configured to cooperate to provide synchronized movement of the second and third upright support members upon actuation by the actuator 30.

The drive members 28a, 28b may be fixedly connected to the upright support members 26a, 26b and/or 26c in any suitable manner, such as with any suitable connectors or fasteners (e.g., clamps, brackets, screws, bolts and nuts, etc.). In the illustrated embodiment, a clamp 40 is used for fixedly connecting the first drive member 28a to each of the first upright support member 26a and the third upright support 26c, and for fixedly connecting the second drive member 28b to the second upright support member 26b. Further details of an example clamp, as well as further details of an example lift with which the knob mechanism 20 may be used, are disclosed in U.S. application Ser. No. 18/593,237 (corresponding to Attorney Docket TERS 0147 PUS) filed on Mar. 1, 2024, which is hereby incorporated by reference in its entirety.

Returning to FIG. 3A, the clamp 40 at location 36a may be fixedly attached to the exterior surface, e.g., the front face, of the first upright support member 26a. The clamp 40 at location 36b may be fixedly attached to a bracket or bracket arrangement 42 (e.g., first and second bracket portions 42a and 42b, respectively) that extends through the second upright support member 26b and is fixedly attached to the third upright support member 26c. For example, the bracket 42 may extend through a longitudinally extending slot or channel 44 (shown in FIG. 2) formed in a side of the second upright support member 26b. With such a configuration, the bracket 42 may move along the channel 44 when the support member arrangement 14 moves between the lowered and raised positions. The clamp 40 at location 38 may be fixedly attached to the exterior surface, e.g., the front face, of the second upright support member 26b.

As also shown in FIG. 3A, the lift 10 may include one or more additional actuators associated with the support member arrangement 14 and configured to assist with movement of the support member arrangement 14. In the illustrated embodiment, the lift 10 includes an additional or second actuator 45, such as a cylinder or gas spring, or any suitable biasing member or spring, having one end connected to the base 12 and an opposite end connected to the second upright support member 26b (e.g., upper end of the second upright support member 26b). With such a configuration, the second actuator 45 may also act as a counterweight, for example,

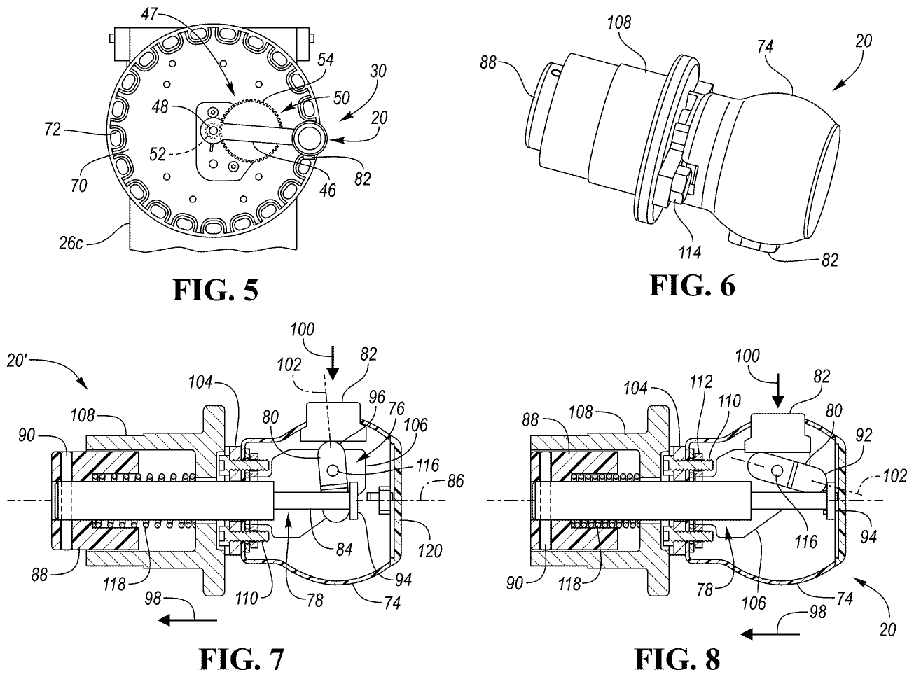

Referring to FIGS. 1-3B, 5 and 6, the actuator 30 includes a rotatable member 46, such as a wheel, disc, hand crank, lever arm, etc., that is configured to move one or more of the drive members 28a, 28b, such as through a transmission 47, and the knob mechanism 20 mounted (e.g., rotatably mounted) on the rotatable member 46. The rotatable member 46 may be mounted on one of the support members 26 and/or on the work platform assembly 18, for example. In the illustrated embodiment, the rotatable member 46 comprises a lever arm mounted on a shaft 48 that is rotatably mounted on the third upright support member 26c, and the transmission 47 includes a gear arrangement 50 that cooperates with the lever arm 46 to transfer force from the lever arm 46 to the second drive member 28b. For example, the gear arrangement 50 may include a first gear 52 at or near an end of the lever arm 46 and that is rotatable with the lever arm 46, and a second gear 54 that is configured to mesh with the first gear 52. In the embodiment shown in FIGS. 3A, 3B and 5, the first gear 52 is fixedly mounted on the shaft 48 to which the lever arm 46 is fixedly mounted, the second gear 54 is connected to a rotatable output shaft 56 that extends through a body of the third upright support member 26c, and the output shaft 56 is fixedly connected to a rotatable drive element 58, such as a pulley, ring, wheel, sheave, etc., that is configured to drive the second drive member 28b upon rotation of the lever arm 46. As explained below, the knob mechanism 20 may be configured to lock the lever arm 46 in a desired position in order to lock the support member arrangement 14 and work platform assembly 18 in a corresponding desired position, or otherwise inhibit or prevent movement of the support member arrangement 14.

Returning to FIG. 1, the work platform assembly 18 is movable with the support member arrangement 14 when the support member arrangement 14 moves between the lowered and raised positions. Specifically, in the illustrated embodiment, the work platform assembly 18 is fixedly mounted on the third upright support member 26c. The work platform assembly 18 includes a base or work platform 60 (e.g., flat work platform) sized to receive and support an operator thereon, and a frame assembly 62, such as a railing assembly, provided on the platform 60. In the illustrated embodiment, the frame assembly 62 extends around, or partially around, a perimeter of the platform 60, and includes multiple frame members, such as toe boards 64, horizontal rails 66, and vertical or upright rails 68, which are connected to the toe boards 64 and the horizontal rails 66. The frame assembly 62 further includes one or more movable (e.g., pivotable) doors 69 to allow operator ingress to, and egress from, the work platform assembly 18.

Referring to FIGS. 5-8, the actuator 30 including the knob mechanism 20 will now be described in more detail. The knob mechanism 20 may be configured to cooperate with a locking member, such as a locking plate, block, bar, etc., to lock the lever arm 46 in one or more desired positions. In the illustrated embodiment, the locking member is formed as a locking plate 70 connected to the third upright support member 26c or the work platform assembly 18 and having multiple locking features, such as locking apertures 72, and the knob mechanism 20 is engageable or otherwise cooperable with any of the apertures 72 in order to lock the lever arm 46 in any one of multiple desired use positions. Specifically, the knob mechanism 20 includes a knob body 74, such as a casing or housing (e.g., curved body, rounded body, rectangular body, etc.), and a lock mechanism 76 associated with the knob body 74. The lock mechanism 76 includes a locking member 78, such as a pin, rod, shaft, column, etc., that is movable between a first or extended position (e.g., locked position or non-actuated position) and a second or retracted position (e.g., released position or actuated position), a pivot member 80, such as a lever, arm, etc., that is pivotable with respect to the knob body 74 to move the locking member 78, and a button 82 that is operable to pivot the pivot member 80 to move the locking member 78 from the extended position toward the retracted position. Referring to FIGS. 1 and 2, the actuator 30 may also be provided with a cover 83, such as a rotatable cover, for covering a main body of the lever arm 46 and the locking plate 70.

In the embodiment shown in FIGS. 7 and 8, the locking member 78 comprises an elongated locking pin 84 having a longitudinal axis 86, and an enlarged locking portion or end 88 attached to the locking pin 84. For example, the locking portion 88 may be attached to the locking pin 84 with a fastener 90 (e.g., connecting pin, bolt, screw, etc.) that extends in a direction transverse to the longitudinal axis 86 of the locking pin 84, or the locking portion 88 may be integrally formed with the locking pin 84 (e.g., the locking portion 88 and the locking pin 84 may be formed as one piece). Furthermore, the pivot member 80 may be engageable with the locking member 78 to move the locking member 78 from the extended position toward the retracted position. In the illustrated embodiment, for example, the pivot member 80 is disposed in an interior of the knob body 74 and has a curved first end 92 that is engageable with an enlarged head 94 of the locking pin 84 when the locking member 78 is in the retracted position shown in FIG. 8. In addition, the button 82 may be slidably mounted on the knob body 74 and engageable with the pivot member 80 to pivot the pivot member 80. For example, the pivot member 80 may have an opposite curved second end 96 that is directly engageable with the button 82 when the locking member 78 is in the extended position shown in FIG. 7. In the embodiment shown in FIGS. 7 and 8, the locking member 78 is movable (e.g., slidable) in a first direction 98 (e.g., parallel to the longitudinal axis 86), and the button 82 is movable (e.g., slidable) in a second direction 100 transverse to the first direction 98 in order to move the locking member 78 in the first direction 98. More specifically, the button 82 is movable in the second direction 100 from a first position (e.g., extended position) shown FIG. 7 to a second position (e.g., depressed position) shown in FIG. 8 in order to pivot the pivot member 80 and thereby move the locking member 78 from the extended position shown in FIG. 7 to the retracted position shown in 8. In the illustrated embodiment, the second direction 100 is perpendicular to the first direction 98. In addition, the knob body 74 may cooperate with the button 82 to guide movement of the button 82 between the first and second positions. For example, the knob body 74 may define an opening having parallel sidewalls that are configured to slidably receive parallel sidewalls of the button 82. With the above configuration, the button 82 may be easily and efficiently actuated when an operator grips the knob body 74.

Referring to FIG. 7, the pivot member 80 may be offset with respect to the second direction 100 when the locking member 78 is in the extended position, in order to facilitate pivotal movement of the pivot member 80 when the button 82 is moved from the first position toward the second position. For example, the pivot member 80 may have a longitudinal axis 102 that extends at an angle greater than 0° (e.g., an angle in the range of 5 to 10°) with respect to the second direction 100 when the locking member 78 is in the extended position.

Referring to FIG. 8, the pivot member 80 may also be offset with respect to the first direction 98 when the locking member 78 is in the retracted position. For example, longitudinal axis 102 of the pivot member 80 may extend at an angle greater than 0° (e.g., an angle in the range of 18 to 25°) with respect to the first direction 98 when the locking member 78 is in the retracted position.

While the knob body 74 and the locking mechanism 76 may be associated with each other in any suitable manner, FIGS. 6-10 show an example configuration for connecting together the knob body 74 and the locking mechanism 76. In the illustrated embodiment, the knob body 74 is attached to a mounting bracket 104 along with an additional bracket or pivot member bracket 106 such that the pivot member bracket 106 is disposed in the interior of the knob body 74, and the knob mechanism 20 further includes a housing 108 that is also connected to the mounting bracket 104 and configured to receive the locking portion 88 of the locking member 78. The knob body 74, the pivot member bracket 106 and the housing 108 may each be connected to the mounting bracket 104 in any suitable manner, such as with one or more fasteners (e.g., screws, bolts, nuts, etc.). In the illustrated embodiment, the knob body 74 and the pivot member bracket 106 are attached to the mounting bracket 104 with two screws or bolts 110 and corresponding nuts 112, and the housing 108 is connected to the mounting bracket 104 with two screws 114 so that the mounting bracket 104 is positioned between the knob body 74 and the housing 108. Furthermore, the pivot member 80 may be pivotally attached to the pivot member bracket 106 in any suitable manner, such as with a pivot pin 116, so that the pivot member 80 is pivotable with respect to the knob body 74 about a pivot axis that may be positioned within the interior of the knob body 74. In the embodiment shown in FIGS. 7 and 8, the pivot axis extends between the button 82 and the locking member 78, and the pivot member 80 is also pivotable with respect to the button 82.

In the illustrated embodiment, the locking member 78 extends through aligned openings formed in the knob body 74, the pivot member bracket 106, the mounting bracket 104 and the housing 108. Furthermore, the housing 108 is configured to slidably receive the locking portion 88 of the locking member 78 as the locking member 78 moves between the extended and retracted positions. The knob mechanism 20 also includes a biasing member disposed in an interior of the housing 108 and that is configured to urge or bias the locking member 78 toward the extended position. For example, the knob mechanism 20 may include a compression spring 118, such as a helical or coil spring, positioned around the locking pin 84 of the locking member 78 so that the spring 118 extends between the locking portion 88 of the locking member 78 and an end of the housing 108 attached to the mounting bracket 104.

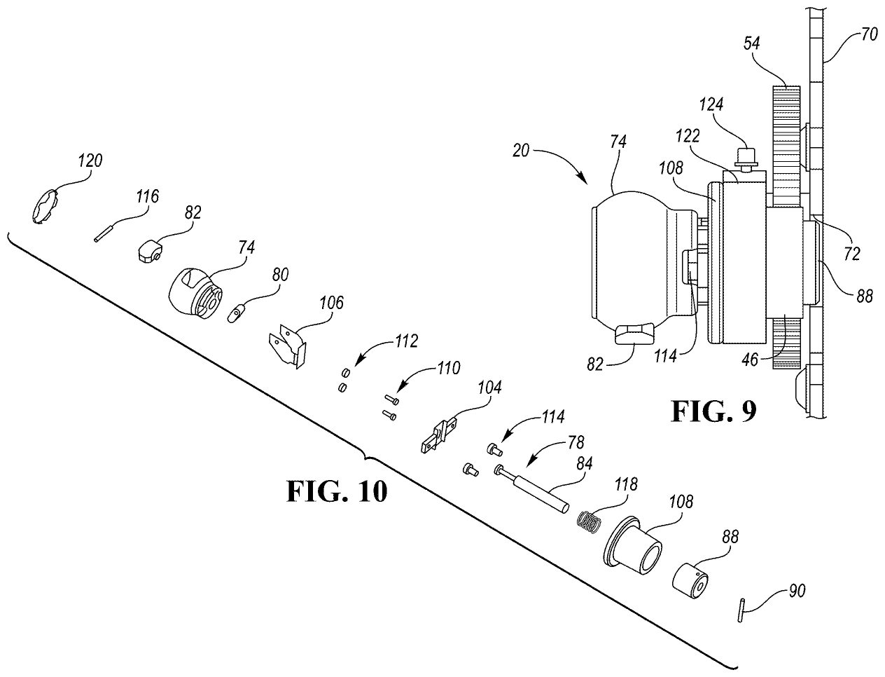

The knob mechanism 20 may be assembled in any suitable manner. For example, referring to FIGS. 7, 8 and 10, the locking pin 84 may be inserted into the locking portion 88 and attached to the locking portion 88 with the fastener 90. Next, the compression spring 118 may be positioned over the locking pin 84 and the locking pin 84 may be inserted through the end of the housing 108 so that the locking portion 88 is received in the housing 108. That subassembly may then be mounted to one side of the mounting bracket 104 using the screws 114. The pivot member 80 may be attached to the pivot member bracket 106 with the pivot pin 116, and the pivot member bracket 106 may then be positioned within the knob body 74. Next, the knob body 74 and pivot member bracket 106 may be attached to the other side of the mounting bracket 104 using the screws 110 and nuts 112. As shown in FIG. 10, the knob body 74 may have an open outer end that provides access to the nuts 112 or other fasteners. The knob mechanism 20 may also include a cap 120, which may be considered part of the knob body 74, for covering the open outer end after assembly of the rest of the knob mechanism 20. The knob mechanism 20 may then be attached in any suitable manner to the lever arm 46 of the actuator 30, or other component if the knob mechanism 20 is used in a different application. Referring to FIG. 9, for example, the housing 108 of the knob mechanism 20 may be inserted into a receptacle 122 on the lever arm 46, and the housing 108 may be attached to the receptacle 122 using one or more fasteners 124, such as a set screw.

Referring to FIGS. 1-9, and as mentioned above, the knob mechanism 20 may be operable to lock the lever arm 46 in one or more desired positions during operation of the lift 10. For example, an operator of the lift 10 may press the button 82 of the knob mechanism 20 inwardly in order to pivot the pivot member 80 and move the locking member 78 from the extended position shown in FIG. 7 to the retracted position shown in FIG. 8 in order to unlock the lever arm 46 from the locking plate 70. The lever arm 46 may then be rotated in a first direction (e.g., clockwise in the embodiment shown in FIGS. 1 and 5) to thereby raise the support member arrangement 14 from the lowered position to the raised position, or a position between the lowered position and the raised position. For example, referring to FIGS. 1-5, when the operator rotates the lever arm 46 in the first direction, such as clockwise in the embodiment shown in FIGS. 1 and 5, the transmission 47 will cause the second drive member 28b to move, e.g., rotate or circulate, in a second direction opposite the first direction, such as counterclockwise in the embodiment shown in FIGS. 3A and 4. As a result, the third upright support member 26c will move upwardly because of the fixed interconnection between the second drive member 28b and the second upright support member 26b. Likewise, the upward movement of the third upright support member 26c will also cause the second upright support member 26b to move upwardly because of the fixed interconnection between the third upright support member 26c and the first drive member 28a (which will move, e.g., rotate or circulate, in the first direction, e.g., clockwise in the embodiment shown in FIGS. 3A and 4) and the fixed interconnection between the first drive member 28a and the first upright support member 26a. Specifically, because of the fixed interconnection between the third upright support member 26c and the first drive member 28a, upward movement of the third upright support member 26c will cause the first drive member 28a to move, e.g., rotate or circulate, in the first direction, e.g., clockwise in the embodiment shown in FIGS. 3A and 4, and that movement will cause the second upright support member 26b to move upwardly because of the fixed interconnection between the first drive member 28a and the first upright support member 26a. The second actuator 45 may also assist in upward movement of the second and third upright support members 26b and 26c, respectively, by urging the second support member 26b upwardly due to the arrangement of the second actuator 45 between the base 12 and the second upright support member 26b.

Referring to FIGS. 7-9, when a desired elevation of the support member arrangement 14 and/or the work platform assembly 18 has been achieved, the operator may stop rotating the lever arm 46 so that movement of the second drive member 28b will stop, and the operator may release the button 82 of the knob mechanism 20 so that the locking member 78 may move toward the extended position and the button 82 may move toward the first position until the locking portion 88 of the knob mechanism 20 is able to be received in one of the locking apertures 72 of the locking plate 70 to thereby lock the lever arm 46 with respect to the locking plate 70. When it is desired to lower the support member arrangement 14 and the work platform assembly 18, the operator may again grasp the knob mechanism 20 and press the button 82 inwardly in order to unlock the lever arm 46 from the locking plate 70. The lever arm 46 may then be rotated in the second direction (e.g., counterclockwise in the embodiment shown in FIGS. 2 and 5) opposite the first direction to thereby lower the support member arrangement 14 to or toward the lowered position. Such movement of the lever arm 46 will cause the second drive member 28b to move, e.g. rotate or circulate, in the first direction, e.g., clockwise in the embodiment shown in FIGS. 3A and 4. As a result, the third upright support member 26c will move downwardly because of the fixed interconnection between the second drive member 28b and the second upright support member 26b. Likewise, the downward movement of the third upright support member 26c will also cause the second upright support member 26b to move downwardly because of the fixed interconnection between the third upright support member 26c and the first drive member 28a (which will move, e.g., rotate or circulate, in the second direction, e.g., counter-clockwise in the embodiment shown in FIGS. 3A and 4) and the fixed interconnection between the first drive member 28a and the first upright support member 26a. The button 82 of the knob mechanism 20 may then be released in order to lock the support member arrangement 14 in the lowered position, or any position between the raised position and the lowered position.

The above configuration of the knob mechanism 20 may provide numerous advantages or benefits. For example, the knob mechanism 20 may allow efficient actuation of the locking member 78 when the operator presses the button 82. Furthermore, when the operator releases the button 82, the spring 118 or other biasing member may urge the locking member 78 toward the extended position to thereby lock the lever arm 46 with respect to the locking plate 70 in order to inhibit or prevent further movement of the support member arrangement 14 and the work platform assembly 18. In addition, the configuration of the knob mechanism 20 may enable easy assembly and disassembly.

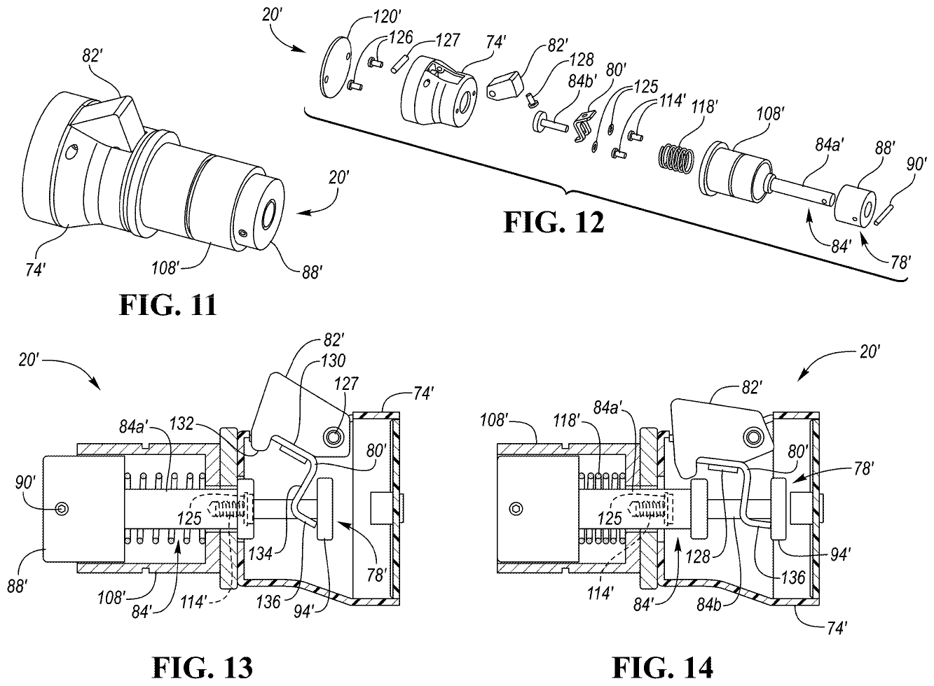

FIGS. 11-14 show another embodiment 20′ of a knob mechanism (e.g., handle mechanism) according to the disclosure, which may be used in any of the applications described above with respect to the knob mechanism 20. The knob mechanism 20′ is similar to the knob mechanism 20, and similar features are identified with the same or similar reference numerals, except the reference numerals for the knob mechanism 20′ may each include a prime mark. Therefore, the below description will primarily focus on features of the knob mechanism 20′ that are different than the knob mechanism 20. For example, with the knob mechanism 20′, knob body 74′ is connected directly to housing 108′ with one or more fasteners, such as screws, bolts, nuts, etc., so the mounting bracket 104 from the knob mechanism 20 is not needed. In the illustrated embodiment, the knob body 74′ is connected to the housing 108′ with two screws 114′ and corresponding washers 125, for example. Like the knob body 74 of the knob mechanism 20, the knob body 74′ may have an open outer end that provides access to the screws 114′ or other fasteners. The knob mechanism 20′ may also include a cap 120′, which may be considered part of the knob body 74′, for covering the open outer end after assembly of the rest of the knob mechanism 20′. The cap 120′ may be attached to a main portion of the knob body 74′ with one or more fasteners, such as screws 126.

As another example, the knob mechanism 20′ includes a locking member 78′ having a locking pin 84′ formed as two pieces that are joined together. Specifically, the locking pin 84′ includes a first or main portion, such as locking pin portion 84a′, and a second portion, such as head portion 84b′, that is fixedly connected to the locking pin portion 84a′ in any suitable manner, such as by a threaded connection. Alternatively, the locking pin 84′ may be formed as one piece.

As yet another example, the knob mechanism 20′ includes a button 82′ that is pivotally connected to the knob body 74′ in any suitable manner, and a pivot member 80′ that is fixedly connected to the button 82′ in any suitable manner. In the illustrated embodiment, for example, the button 82′ is pivotally connected to the knob body 74′ with one or more fasteners, such as a pivot pin 127, and the pivot member 80′ is fixedly connected to the button 82′ with one or more fasteners, such as a screw 128. In another embodiment, the pivot member 80′ may be integrally formed with the button 82′ (e.g., the pivot member 80′and the button 82′ may be formed as one piece). While the pivot member 80′ may have any suitable configuration, in the illustrated embodiment the pivot member 80′ has a generally Z-shaped configuration with a first flat portion 130 attached to the button 82′ so that an edge of the first flat portion 130 abuts a lip or projection 132 formed on a button body of the button 82′. The pivot member 80′ further has a second flat portion 134 that extends transversely to the first flat portion 130, and a third flat portion 136 that extends transversely to the second flat portion 134 and generally parallel to the first flat portion 130. The second and third flat portions 134 and 136, respectively, also define an opening for receiving the head portion 84b′ of the locking member 78′.

As with the knob mechanism 20, the button 82′ of the knob mechanism 20′ is operable to pivot the pivot member 80′ to move the locking member 78′ from a first or extended position (e.g., locked position or non-actuated position) shown in FIG. 13 toward a second or retracted position (e.g., released position or actuated position) shown in FIG. 14. Specifically, the pivot member 80′ is pivotable with the button 82′ as the button 82′ pivots between a first position shown in FIG. 13 and a second position shown in FIG. 14. The pivot member 80′ is also engageable with the head portion 84b′ of the locking member 78′ in order to move the locking member 78′ from the extended position to the retracted position. For example, the third flat portion 136 of the pivot member 80′ may be directly engageable with an enlarged head 94′ of the head portion 84b′.

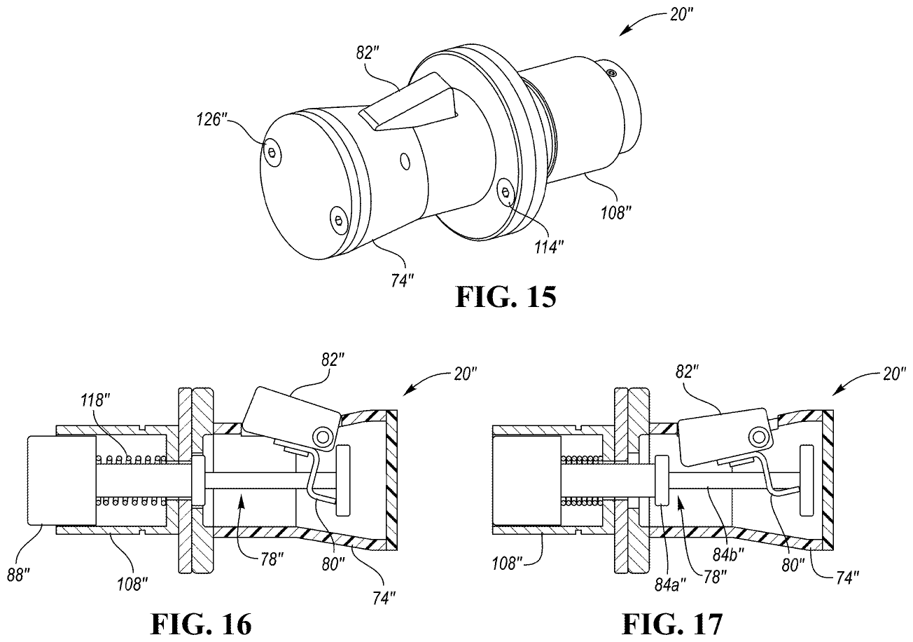

FIGS. 15-17 show yet another embodiment 20″ of a knob mechanism (e.g., handle mechanism) according to the disclosure, which may be used in any of the applications described above with respect to the knob mechanism 20. The knob mechanism 20″ is generally similar to the knob mechanism 20′, and similar features are identified with the same or similar reference numerals, except the reference numerals for the knob mechanism 20″ may each include a double prime mark. Therefore, the below description will primarily focus on features of the knob mechanism 20″ that are different than the knob mechanism 20′. For example, the knob mechanism 20″ may include a knob body 74″ having a different configuration than the knob body 74′ of the knob mechanism 20′. In that regard, the knob body 74″ may include a main portion having a smaller diameter than a corresponding main portion of the knob body 74′ so that the knob body 74″ may be joined to housing 108″ with one or more fasteners, such as screws 114″, that are accessible from an exterior of the knob body 74″. The knob body 74″ may also have a larger length than the corresponding main portion of the knob body 74′. Likewise, locking member 78″ of the knob mechanism 20″ may include first portion, such as locking pin portion 84a″, and/or a second portion, such as head portion 84b″, that are longer than the respective locking pin portion 84a′ and head portion 84b′ of the locking member 78′.

The knob mechanism 20′ and the knob mechanism 20″ may provide the same or similar advantages or benefits as described above with respect to the knob mechanism 20.

The following clauses describe aspects of embodiments according to the disclosure.

Clause 1. A knob mechanism according to the disclosure may include a knob body and a lock mechanism associated with the knob body. The lock mechanism may include a locking member that is movable between an extended position and a retracted position, a pivot member that is pivotable with respect to the knob body to move the locking member, and a button that is operable to pivot the pivot member to move the locking member from the extended position toward the retracted position.

Clause 2. The knob mechanism of the preceding clause wherein the pivot member is engageable with the locking member to move the locking member from the extended position toward the retracted position.

Clause 3. The knob mechanism of any of the preceding clauses wherein the pivot member has a curved end that is engageable with the locking member when the locking member is in the retracted position.

Clause 4. The knob mechanism of any of the preceding clauses wherein the button is engageable with the pivot member to pivot the pivot member.

Clause 5. The knob mechanism of any of the preceding clauses wherein the pivot member has a curved end that is engageable with the button when the locking member is in the extended position.

Clause 6. The knob mechanism of any of the preceding clauses wherein the locking member is movable in a first direction, and the button is movable in a second direction transverse to the first direction.

Clause 7. The knob mechanism of clause 6 wherein the second direction is perpendicular to the first direction.

Clause 8. The knob mechanism of clause 6 wherein the pivot member has a longitudinal axis that extends at an angle greater than 0° with respect to the second direction when the locking member is in the extended position.

Clause 9. The knob mechanism of any of clauses 6-9 wherein the pivot member has a longitudinal axis that extends at an angle greater than 0° with respect to the first direction when the locking member is in the retracted position.

Clause 10. The knob mechanism of any of clauses 1-4 wherein the button is pivotally attached to the knob body.

Clause 11. The knob mechanism of clause 10 wherein the pivot member is fixedly attached to the button.

Clause 12. The knob mechanism of any preceding clause wherein the pivot member has an opening through which the locking member extends.

Clause 13. The knob mechanism of any preceding clause wherein the locking member comprises an elongated locking pin and an enlarged locking portion attached to the locking pin.

Clause 14. The knob mechanism of clause 13 wherein the locking portion is attached to the locking pin with a fastener that extends in a direction transverse to a longitudinal axis of the locking pin.

Clause 15. The knob mechanism of any of clauses 1-10 and 12-14 wherein the pivot member is pivotable about a pivot axis that extends between the button and the locking member.

Clause 16. The knob mechanism of any of clauses 1-10 and 12-15 further comprising a bracket disposed in an interior of the knob body, and the pivot member is pivotally attached to the bracket.

Clause 17. The knob mechanism of any preceding clause further comprising a housing attached to the knob body, and a biasing member disposed in an interior of the housing and configured to bias the locking member toward the extended position.

Clause 18. The knob mechanism of clause 17 wherein the biasing member comprises a compression spring.

Clause 19. The knob mechanism of any of clauses 17-18 further comprising a mounting bracket disposed between the housing and the knob body, wherein the locking member extends through the mounting bracket.

Clause 20. The knob mechanism of any of clauses 17-18 wherein the housing is attached to the knob body with one or more fasteners that are accessible from an interior of the knob body.

Clause 21. A lift device comprising a work platform; a movable support member arrangement that supports the work platform; and a drive system configured to move the support member arrangement in order to move the work platform, wherein the drive system includes an actuator that comprises the knob mechanism of any preceding clause.

Clause 22. The lift device of clause 21 wherein the actuator comprises a rotatable member, and the knob mechanism is mounted on the rotatable member.

Clause 23. The lift device of clause 22 further comprising a locking member mounted on the work platform or the support member arrangement, wherein the locking member of the knob mechanism is engageable with the locking member on the work platform or the support member arrangement to lock the rotatable member with respect to the work platform or the support member arrangement.

Clause 24. Any of the preceding clauses 1-23 in any combination.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure. For example, the features of any one of the knob mechanism embodiments described above may be incorporated into any of the other above described embodiments.

1. A knob mechanism comprising:
a knob body; and
a lock mechanism associated with the knob body, the lock mechanism comprising a locking member that is movable between an extended position and a retracted position, a pivot member that is pivotable with respect to the knob body to move the locking member, and a button that is operable to pivot the pivot member to move the locking member from the extended position toward the retracted position.

2. The knob mechanism of claim 1 wherein the pivot member is engageable with the locking member to move the locking member from the extended position toward the retracted position.

3. The knob mechanism of claim 2 wherein the pivot member has a curved end that is engageable with the locking member when the locking member is in the retracted position.

4. The knob mechanism of claim 2 wherein the button is engageable with the pivot member to pivot the pivot member.

5. The knob mechanism of claim 4 wherein the pivot member has a curved end that is engageable with the button when the locking member is in the extended position.

6. The knob mechanism of claim 1 wherein the locking member is movable in a first direction, and the button is movable in a second direction transverse to the first direction.

7. The knob mechanism of claim 6 wherein the pivot member has a longitudinal axis that extends at an angle greater than 0° with respect to the second direction when the locking member is in the extended position.

8. The knob mechanism of claim 1 wherein the button is pivotally attached to the knob body.

9. The knob mechanism of claim 1 wherein the pivot member is fixedly attached to the button.

10. The knob mechanism of claim 9 wherein the pivot member is integrally formed with the button.

11. The knob mechanism of claim 1 wherein the pivot member has an opening through which the locking member extends.

12. The knob mechanism of claim 1 wherein the locking member comprises an elongated locking pin and an enlarged locking portion attached to the locking pin.

13. The knob mechanism of claim 1 wherein the pivot member is pivotable about a pivot axis that extends between the button and the locking member.

14. The knob mechanism of claim 1 further comprising a housing attached to the knob body, and a biasing member disposed in an interior of the housing and configured to bias the locking member toward the extended position.

15. The knob mechanism of claim 14 wherein the biasing member comprises a compression spring.

16. The knob mechanism of claim 14 wherein the housing is attached to the knob body with one or more fasteners that are accessible from an interior of the knob body.

17. The knob mechanism of claim 14 wherein the housing is attached to the knob body with one or more fasteners that are accessible from an exterior of the knob body.

18. A lift device comprising:
a work platform;
a movable support member arrangement that supports the work platform; and
a drive system configured to move the support member arrangement in order to move the work platform, the drive system including an actuator that comprises the knob mechanism of claim 1.

19. The lift device of claim 18 wherein the actuator comprises a rotatable member, and the knob mechanism is mounted on the rotatable member.

20. The lift device of claim 19 further comprising a locking member mounted on the work platform or the support member arrangement, wherein the locking member of the knob mechanism is engageable with the locking member on the work platform or the support member arrangement to lock the rotatable member with respect to the work platform or the support member arrangement.
